(19) United States
(12) Patent Application Publication
(10) Pub. No.: US 2026/0064949 A1
(43) Pub. Date: Mar. 5, 2026

(54) AUGMENTED LANGUAGE MODEL FOR ARTIFACT EXTRACTION

(71) Applicant: Intuit Inc., Mountain View, CA (US)

(72) Inventors: Richard Joel BECKER, St. Albert (CA); Karelia Del Carmen PENA-PENA, Wilmington, DE (US); Raj Brij SRIVASTAVA, Mountain View, CA (US); Joey-Michael FALLONE, Edmonton (CA)

(73) Assignee: Intuit Inc., Mountain View, CA (US)

(21) Appl. No.: 18/820,053

(22) Filed: Aug. 29, 2024

(51) Int. Cl. G06F 40/174; G06F 40/194; G06V 10/80; G06V 30/412; G06V 30/413

(52) U.S. Cl. CPC G06F 40/174; G06F 40/194; G06V 10/811; G06V 30/412; G06V 30/413

(57) ABSTRACT

A method including applying an image processing application to an electronic document to generate image processing data describing artifacts in the electronic document. The method also includes applying a server controller to the image processing data to generate at least one relationship among the artifacts. The method also includes converting the at least one relationship and the artifacts into an object notation language data structure. The method also includes generating a multimodal prompt for a language model by combining the object notation language data structure, a reference to the electronic document, and a prompt template. The prompt template includes instructions for the language model to extract segments from the electronic document. The method also includes applying, according to the multimodal prompt, the language model to the electronic document to extract, from the electronic document, the segments and a segment relationship among the segments. The method also includes returning the segments.

### BACKGROUND

Language models process text and also may process images containing text. An example of a language model may be a large language model, such as CHATGPT®, though other language models exist.

A technical problem that language models have when processing electronic documents including images is that the language models may hallucinate. The term “hallucinate,” when used in conjunction with machine learning models such as language models, means that the machine learning model generates output that is unexpected, nonsensical, clearly wrong, or a combination thereof. Thus, for example, a large language model asked to summarize an image file representing an electronic document may generate results that are nonsensical, wrong, or otherwise undesirable (i.e., the large language model “hallucinates”).

### SUMMARY

One or more embodiments provide for a method. The method includes applying an image processing application to an electronic document to generate image processing data describing artifacts in the electronic document. The method also includes applying a server controller to the image processing data to generate at least one relationship among the artifacts. The method also includes converting the at least one relationship and the artifacts into an object notation language data structure. The method also includes generating a multimodal prompt for a language model by combining the object notation language data structure, a reference to the electronic document, and a prompt template. The prompt template includes instructions for the language model to extract segments from the electronic document. The method also includes applying, according to the multimodal prompt, the language model to the electronic document to extract, from the electronic document, the segments and a segment relationship among the segments. The method also includes returning the segments.

One or more embodiments provide for another method. The method includes applying a server controller to determine a difference between a first dataset and a second dataset. The first dataset includes artifacts extracted from an electronic document by an image processing application. The second dataset includes segments extracted from the electronic document by a language model. The method also includes augmenting, to generate an updated segment using the difference, at least one of the segments extracted by the language model. Augmenting at least includes modifying the at least one of the segments using the first dataset. The method also includes returning modified segments. The modified segments are the segments in which the updated segment replaces the at least one of the segments.

One or more embodiments also provide for a system. The system includes a computer processor and a data repository in communication with the computer processor. The data repository stores an electronic document. The data repository also stores a reference to the electronic document. The data repository also stores image processing data describing artifacts in the electronic document. The data repository also stores at least one relationship among the artifacts. The data repository also stores an object notation language data structure. The data repository also stores a prompt template including natural language instructions to extract segments from the electronic document. The data repository also stores a multimodal prompt. The data repository also stores a segment relationship among the segments. The system also includes an image processing application programmed, when executed by the computer processor, to generate the image processing data from the electronic document. The system also includes a server controller programmed, when executed by the computer processor, to generate, from the image processing data, the at least one relationship among the artifacts. The server controller is also programmed to convert the at least one relationship and the artifacts into the object notation language data structure. The server controller is also programmed to generate the multimodal prompt by combining object notation language data structure, the reference to the electronic document, and the prompt template. The server controller is also programmed to return the segments. The system also includes a language model programmed, when executed by the computer processor according to the multimodal prompt, to extract, from the electronic document, the segments and the segment relationship.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for artifact extraction using an augmented language model, in accordance with one or more embodiments.

FIG. 3 shows a flowchart of a method for validating and updating artifacts extracted by the method of FIG. 2, in accordance with one or more embodiments.

FIG. 4A, FIG. 4B, FIG. 4C, FIG. 4D, FIG. 4E, and FIG. 4F show an example of artifact extraction, validation, and enhancement using an augmented language model, in accordance with one or more embodiments.

FIG. 5A and FIG. 5B show an example of a computing system and a network environment, in accordance with one or more embodiments.

Like elements in the various figures are denoted by like reference numerals for consistency.

### DETAILED DESCRIPTION

One or more embodiments are directed to methods and systems for extracting artifacts from electronic documents using an augmented language model. Language models may be useful for analyzing and decomposing electronic forms, including images. Other form processing programs may be useful. For example, Optical Character Recognition (OCR) programs may extract text from an electronic document. Computer Vision (CV) programs may extract bounding boxes and the position of the bounding boxes from an electronic document. However, such programs cannot properly associate the relationships among the bounding boxes and text. The relationships between the bounding boxes and text may be of significant value to a particular automated data processing task.

For example, the electronic document may be an image of a tax form. While programs, such as OCR and CV, may extract the text of the instructions and the bounding boxes of the form, such programs do not associate the instructions to the boxes. Similarly, such programs do not associate the fact that some bounding boxes are intended to represent a place to insert a value of a field for another bounding box. However, it would be desirable to automatically include such relationships or other information in the output of the programs.

In one or more embodiments, a multimodal language model may be used to analyze an electronic form. The output of the multimodal language model is artifacts (text, bounding boxes, check boxes, etc.), and further output the relationships among the artifacts. Artifacts and relationships extracted from an electronic form may be referred to as segments.

A multimodal language model is a machine learning model that may process both text and images concurrently. Thus, for example, a multimodal language model, when applied to an electronic document, may be used to specify that a bounding box next to a particular string of text represents a value that is meant to be inserted according to the instructions presented in the text. The resulting data structure output by the multimodal language model includes both the artifacts and the relationship between the artifacts. The resulting data structure then may be used to generate, or be used by, other computer programs. For example, the data structure output by the language model may be used to generate, or be used by, programs that automatically process the form.

However, as indicated above, multimodal language models may be prone to hallucination. Thus, multimodal language models may not be sufficiently reliable for a particular data processing objective when analyzing electronic forms. For example, the multimodal language model may incorrectly associate bounding boxes and text.

Accordingly, a technical problem is presented. The technical problem is how to augment a language model to process an electronic form and yet prevent model hallucination or reduce model hallucination to an acceptable rate of hallucination, as determined by a computer scientist.

One or more embodiments address the above-described technical problem with a technical solution. While the technical solution is best described by the following figures, description, and claims, the technical solution involves generating image processing data from programs such as OCR and CV. Then, one or more embodiments use the image processing data to generate an enhanced prompt for the language model. The enhanced prompt reduces or eliminates model hallucination, and further improves the output of the language model. In turn, the quality of the data structure output by the language model also is improved. In other words, the enhanced prompt instructs the multimodal language model regarding the structure of the electronic document, thereby reducing or preventing model hallucination with respect to the electronic document.

As described further below, a prompt is an instruction to a language model. Thus, for example, a prompt may instruct the language model, in natural language: “Please analyze the referenced electronic form to identify text and bounding boxes.” However, as indicated above, such a simplistic prompt is likely to result in language model hallucination.

One or more embodiments employ the techniques described below to add the image processing data to the prompt. As a result, the language model is provided with a context and a structure of the form when processing the instruction to “please analyze.” Accordingly, the language model, effectively an augmented language model by way of the improved prompt, is able to more accurately process the electronic form. Hence, the resulting output is improved, and model hallucinations are reduced or eliminated. The resulting improved data structure output by the language model then may be used for other data processing projects (e.g., the encoded tax form described above may be used by tax preparation software).

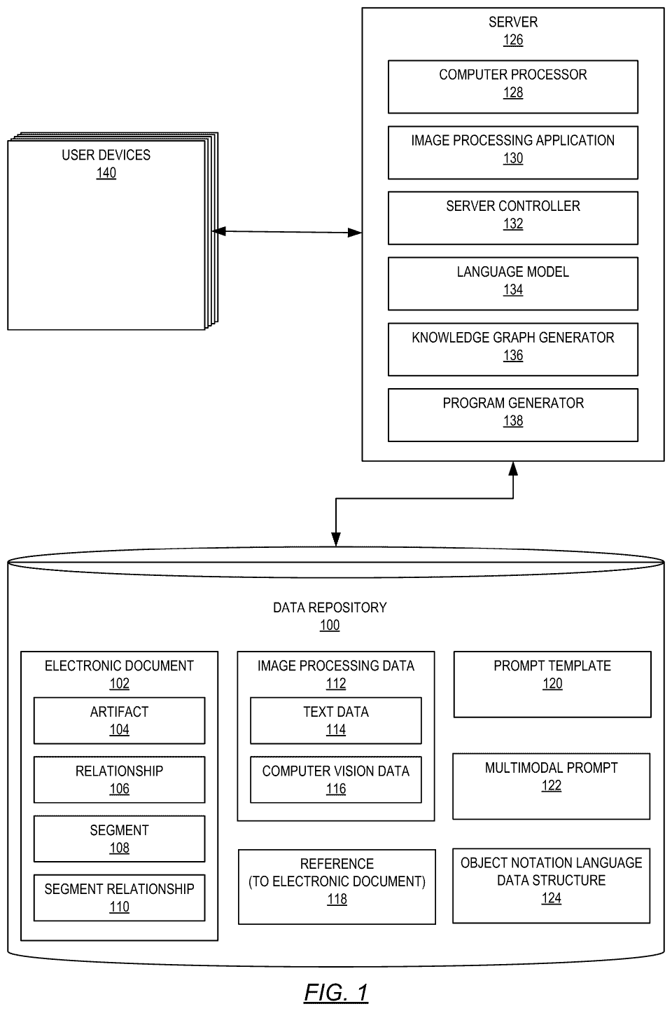

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) may store an electronic document (102). The electronic document (102) is a computer readable data structure which, when processed by an application programmed to read the data structure, may be displayed on a display device. The electronic document (102) may include both text and images. Examples of the electronic document (102) include electronic forms, websites, scans of paper documents, facsimile transmissions, word processing documents, Portable Document Format (PDF) documents, etc.

The electronic document (102) contains one or more artifacts, such as artifact (104). The artifact (104) is alphanumeric text or a set of contiguous, or closely associated, pixels that form an image. The term “closely associated” means that two pixels are close enough to each other to be deemed, by an image processing program or a multimodal language model, as being part of a single, larger image. Examples of the artifact (104) include strings of text (e.g., words, sentences, etc.), special characters (e.g., “*,” “!,” “@,” etc.). More generally, the artifact (104) may be a bounding box, a text string, a text string within a bounding box, a text string outside a bounding box, a bar code, a Quick Response (QR) code, a contour of the electronic document, a field, a checkbox, an amount of pixel fill within a bounding box, and others.

The electronic document (102) includes a relationship (106). The relationship (106) is a relationship between two or more artifacts, such as the artifact (104). The relationship may be an association between two or more artifacts.

For example, if one artifact is text and another artifact is a bounding box, then the text may be associated with the bounding box. In another example, if both artifacts are text, then the text may be associated with each other. In still another example, if both artifacts are bounding boxes, then the bounding boxes may be associated with each other. In a specific example, one of the artifacts is text expressing instructions for filling out the electronic document (102), and the other artifact is a bounding box for holding value for the instructions, then the relationship (106) for the text and the bounding box is one of key (i.e., the text) and value (i.e., the bounding box).

The relationship (106) also may be defined in terms of a coordinate system defined for the electronic document (102). For example, the relationship (106) may be an expression of the position the artifact (104) in the electronic document (102) with respect to the coordinate system. The relationship (106) also may be an expression of the relative positions of two artifacts relative to the coordinate system. Specifically, the relationship (106) may be a distance, direction, or both between two artifacts, relative to the coordinate system.

The electronic document (102) also may include a segment (108). The segment (108) is a broader term for information contained in the electronic document (102), relative to the artifact (104) and the relationship (106). Specifically, the segment (108) may be either an artifact (104) or the relationship (106), or a combination of the artifact (104) and the relationship (106).

The artifact (104) also may include a segment relationship (110). The segment relationship (110) is a relationship among segments. For example, a first segment in the electronic document (102) may be a combination of a bounding box, text, and the relationship between the bounding box and text. A second segment in the electronic document (102) may be a combination of a check box and a bounding box. A relationship may exist between the first segment and the second segment. For example, the second segment may be an indication that additional information on the electronic document (102) should be filled-out. Then, if the check box is checked, the text provides instructions for providing a value within the bounding box of the first segment. Thus, the first segment and the second segment are related to each other. The relationship may be defined by the segment relationship (110).

The data repository (100) also may store image processing data (112). The image processing data (112) is data generated by application of an image processing application, such as the image processing application (130) (defined below). An example of the image processing data (112) may be text generated by application of an OCR program to the electronic document (102). Another example of the image processing data (112) may be definitions of bounding boxes within the electronic document (102), as generated by a CV program when applied to the electronic document (102). The image processing data (112) may include other data, depending on the nature of the image processing application (130) applied to the electronic document (102).

The image processing data (112) may include text data (114). The text data (114) is text extracted from the electronic document (102). For example, if the image processing application (130) is an OCR program, then the OCR program generates the text data (114).

However, if the image processing application (130) is a CV program, then the CV program generates the computer vision data (116). The computer vision data (116) includes a coordinate system defined for the electronic document (102), as well as data indicating the positions of contiguous pixels, or nearby pixels, that form pictorial objects within the electronic document (102) (e.g., bounding boxes, check boxes, pictures, etc.).

The data repository (100) also may store a reference (118). The reference (118) is a reference, expressed in natural language format, to the electronic document (102). The reference (118) is included in the multimodal prompt (122) or may be included in the prompt template (120) during the methods described herein. The reference (118) instructs the language model (134) where the electronic document (102) may be accessed. In an embodiment, the reference (118) may be a copy of the electronic document (102) itself (i.e., the electronic document (102) is embedded in the multimodal prompt (122) or the prompt template (120)).

The data repository (100) also may store a prompt template (120). The prompt template (120) is a set of natural language text that forms the basis of the multimodal prompt (122). For example, the prompt template (120) may include a general system message, a draft of language to be used to designate the reference (118), an outline of a command to output the execution of the language model (134) in a particular format, or any other instructions for the language model (134) that are deemed desirable for a specific multimodal prompt (122) that is to be used in a particular implementation. The prompt template (120) may be stored in a non-transitory computer readable storage medium, and then accessed and modified according to the methods described herein to build the multimodal prompt (122).

The data repository (100) also stores a multimodal prompt (122). The multimodal prompt (122) is a prompt that provides natural language instructions to a language model, such as the language model (134). When the computer processor (128) executes the language model (134), the language model (134) will be applied to the electronic document (102) according to the instructions expressed in the multimodal prompt (122). Additional details regarding the functions of the language model (134) are described below.

The data repository (100) also stores an object notation language data structure (124). The object notation language data structure (124) is a data structure that stores data expressed in an object notation language. An example of an object notation language is JAVASCRIPT® Object Notation Language (JSON). The object notation language data structure (124) is used in the multimodal prompt (122) to structure the instructions to the language model (134), and possibly to instruct the language model (134) how to structure the output of the language model (134).

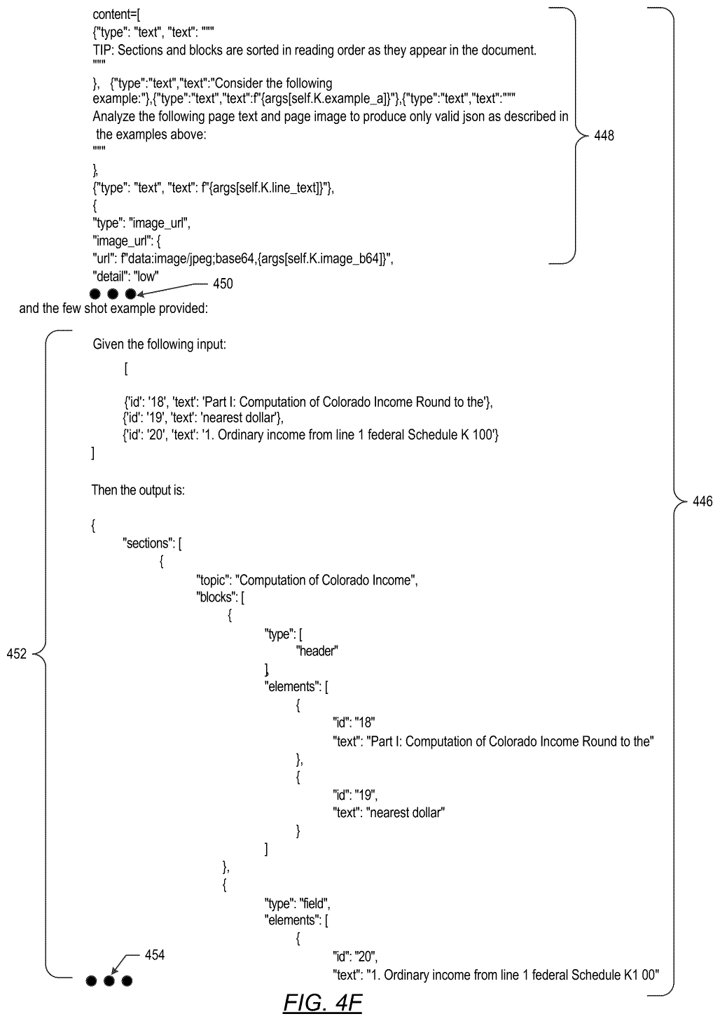

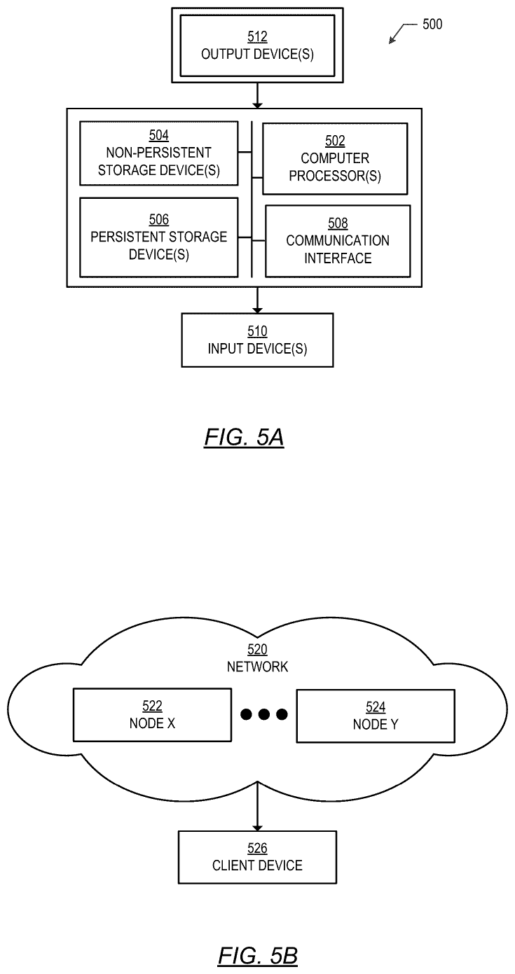

The system shown in FIG. 1A may include other components. For example, the system shown in FIG. 1A also may include a server (126). The server (126) is one or more computer processors, data repositories, communication devices, and supporting hardware and software. The server (126) may be in a distributed computing environment. The server (126) is configured to execute one or more applications, such as the image processing application (130), the server controller (132), the language model (134), the knowledge graph generator (136), and the program generator (138). An example of a computer system and network that may form the server (126) is described with respect to FIG. 5A and FIG. 5B.

The server (126) includes a computer processor (128). The computer processor (128) is one or more hardware or virtual processors which may execute computer readable program code that defines one or more applications, such as the image processing application (130), the server controller (132), the language model (134), the knowledge graph generator (136), and the program generator (138). An example of the computer processor (128) is described with respect to the computer processor(s) (502) of FIG. 5A.

The server (126) also includes an image processing application (130). The image processing application (130) is software or application specific hardware which, when executed by the computer processor (128), processes the electronic document (102) to generate the image processing data (112). The image processing application (130) is not the language model (134). Examples of the image processing application (130) include optical character recognition (OCR) applications, computer vision (CV) applications, etc.

The server (126) also may include a server controller (132). The server controller (132) is software or application specific hardware which, when executed by the computer processor (128), controls and coordinates operation of the software or application specific hardware described herein. Thus, the sever controller (132) may control and coordinate execution of the image processing application (130), the language model (134), the knowledge graph generator (136), and the program generator (138).

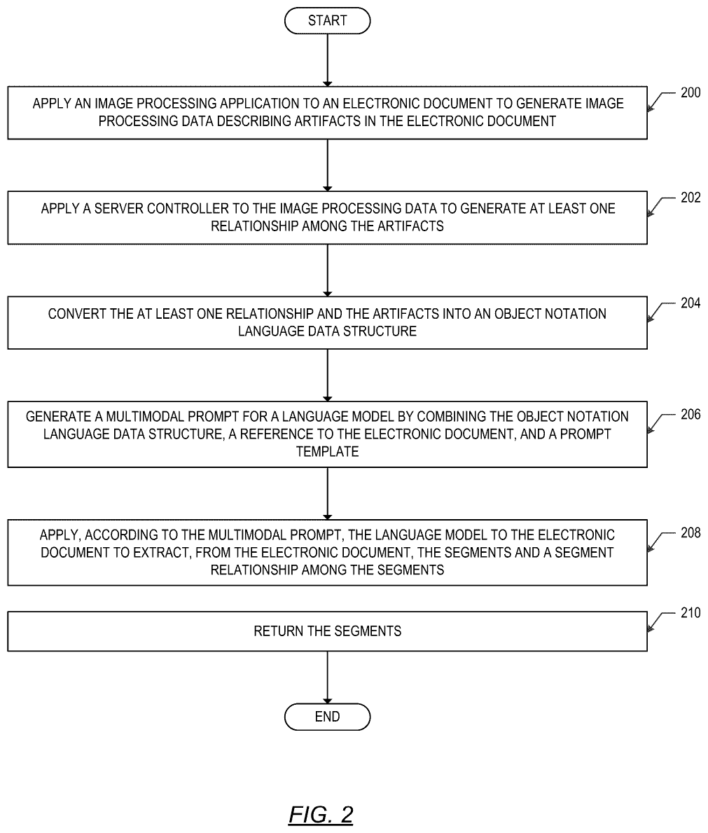

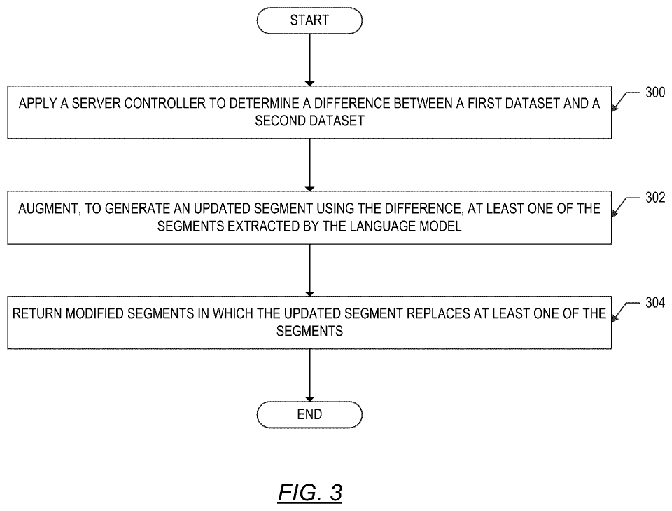

The server (126) also includes a language model (134). The language model (134) is a natural language processing machine learning model. An example of the language model (134) may be a large language model, such as CHATGPT®. However, different language models may be used. Use of the language model (134) is described with respect to FIG. 2 and FIG. 3.

The server (126) also includes a knowledge graph generator (136). The knowledge graph generator (136) is software or application specific hardware which, when executed by the computer processor (128), generates a knowledge graph from the output of the language model (134). The output of the language model (134) may be in the form of the object notation language data structure (124). A knowledge graph is a graph database structure composed of nodes and edges. A node represents or stores data. The edges define the relationships among the data. The knowledge graph may be used for other data processing tasks, as described further below. For example, the knowledge graph may be used by a program generated by the program generator (138).

The server (126) also includes a program generator (138). The program generator (138) is software or application specific hardware which, when executed by the computer processor (128), generates a program for which the knowledge graph output by the knowledge graph generator (136) will be useful. For example, the program generated by the program generator (138) may be generated, in part, based on the knowledge graph. In another example, the program generated by the program generator (138) may use the knowledge graph as part of the ordinary execution of the program.

The system shown in FIG. 1A also may include one or more user devices (140). The user devices (140) may be considered remote or local. A remote user device is a device operated by a third-party (e.g., an end user of a chatbot) that does not control or operate the system of FIG. 1A. Similarly, the organization that controls the other elements of the system of FIG. 1A may not control or operate the remote user device. Thus, a remote user device may not be considered part of the system of FIG. 1A.

In contrast, a local user device is a device operated under the control of the organization that controls the other components of the system of FIG. 1A. Thus, a local user device may be considered part of the system of FIG. 1A.

In any case, the user devices (140) are computing systems (e.g., the computing system (500) shown in FIG. 5A) that communicate with the server (126). The user prompt may be received from one or more of the user devices (140). In another embodiment, one or more of the user devices (140) may be operated by a computer technician that services the various components of the system shown in FIG. 1A.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for artifact extraction using an augmented language model, in accordance with one or more embodiments. The method of FIG. 2 may be performed using the system shown in FIG. 1.

Step 200 includes applying an image processing application to an electronic document to generate image processing data describing artifacts in the electronic document. The electronic document is provided as input to the image processing application. If multiple image processing applications are being used (e.g., an OCR application and a CV application), then the multiple image processing applications are applied to the electronic document. The image processing applications are executed by the processor of a server or other computer.

In an example, the electronic document may include a number of pixels. In this case, applying the image processing application may include the pixels to identify the artifacts.

Analyzing the pixels may include identifying contiguous pixels that form text. In this case, step 200 also may include further identifying a font size, font type, and a language formed by the text. In another example, analyzing the pixels may include identifying contiguous pixels that form a bounding box and a relationship of textual content relative to the bounding box.

Step 202 includes applying a server controller to the image processing data to generate at least one relationship among the artifacts. The server controller may define the relationship by referring to a coordinate system defined for the electronic document (102) by the image processing application. Thus, for example, if one of the artifacts is a bounding box within a pre-determined distance of another artifact that also is a bounding box, then the two bounding boxes may be defined as being related to each other. Similarly, other artifacts may be deemed related based on reference to the coordinate system. For example, text contained within the bounding box may be deemed as being related to each other. Many different relationship types are possible among the artifacts.

Step 204 includes converting the at least one relationship among the artifacts into an object notation language data structure. The server controller may use a data conversion program to convert the structure of the output of the image processing application into the object notation language. Thus, the data structure of the image processing application is converted into an object notation language data structure.

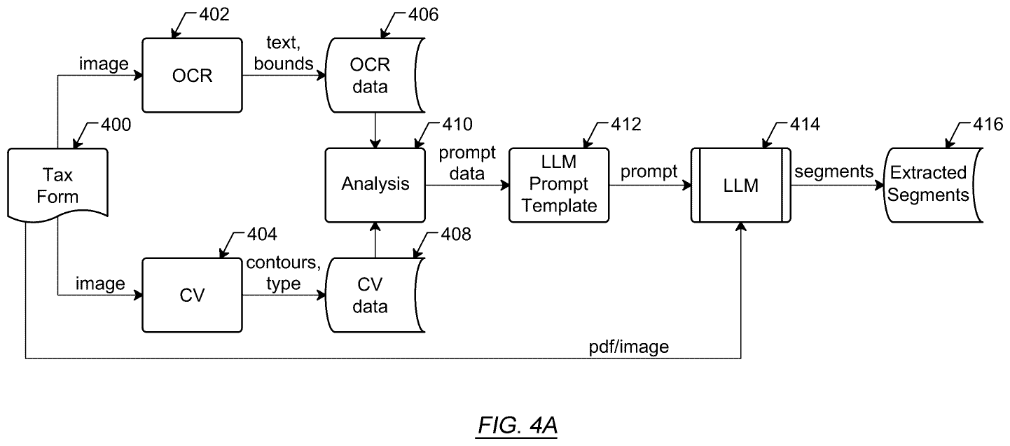

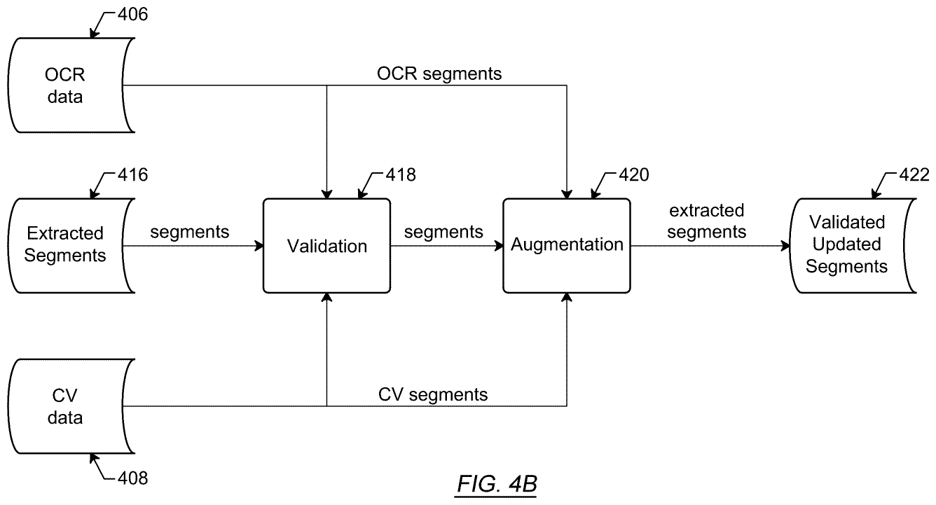

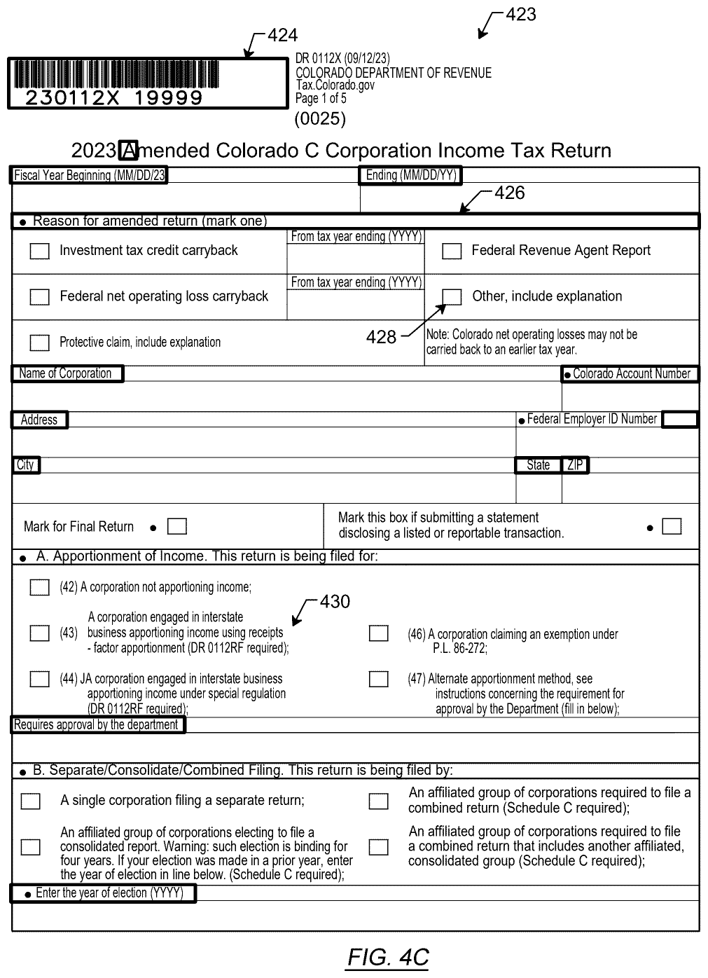

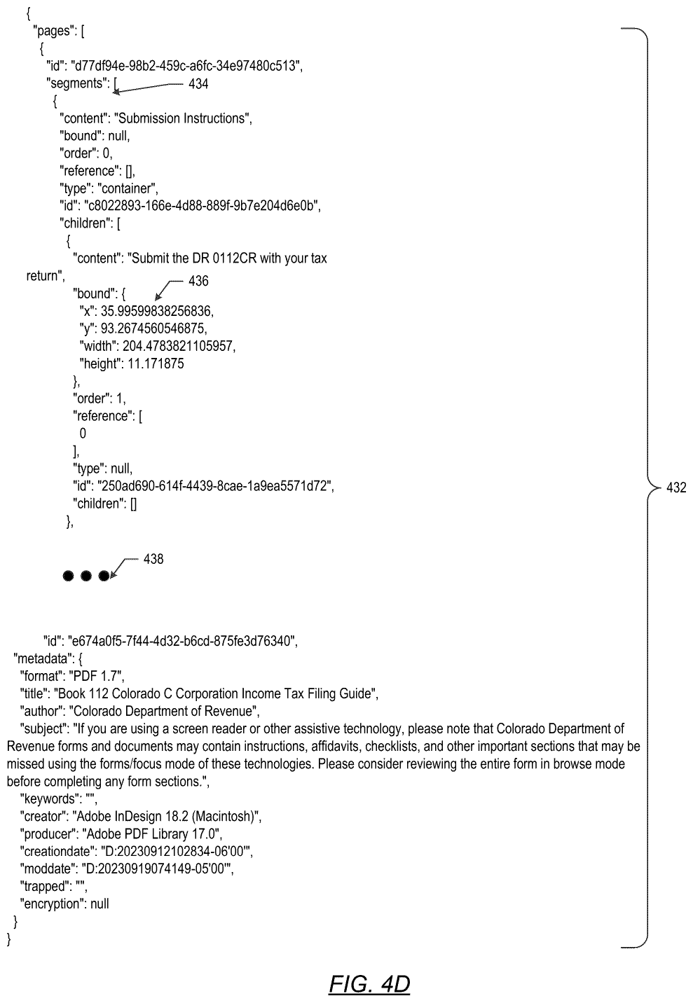

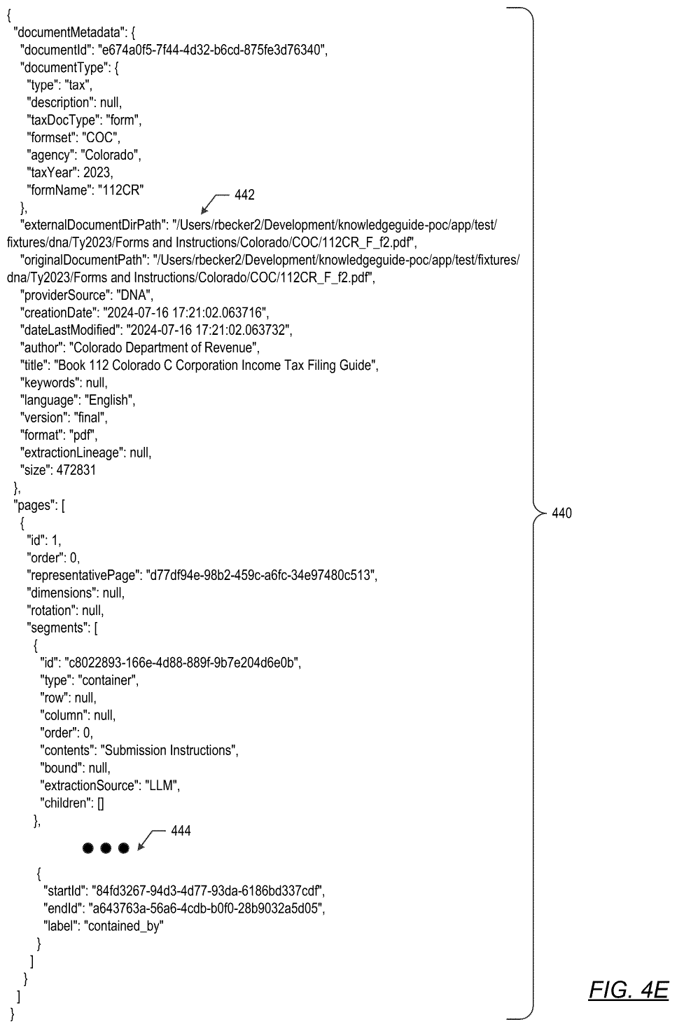

An example of the output of the image processing application may be text output by an OCR application. The text is converted into an object notation language data structure. Another example of the output image processing application may be computer vision output which defines the relationships among pixels or groups of pixels within the image that forms the electronic document. The output, again, may be converted into numbers or text described in the object notation language. Examples of the object notation language data structures are shown in FIG. 4D and FIG. 4E.

In an embodiment, the at least one relationship and the artifacts may be a bounding box and text associated with the bounding box. In this case, converting includes establishing a coordinate system for the electronic document. Converting then may include identifying, in the object notation language data structure, the text as content. Converting then may include reproducing, in the object notation language data structure, the text as being directly associated with the content. Converting then may include identifying, in the object notation language data structure, the bounding box as a bound. Converting then may include specifying, in the object notation language data structure, coordinates of the bounding box relative to the coordinate system. Converting then may include specifying, in the object notation language data structure, a relationship between the bounding box and the text.

The above examples do not necessarily limit how the at least one relationship and the artifacts are converted into an object notation language. Many other procedures may be used, depending on the nature of the artifacts.

Step 206 includes generating a multimodal prompt for a language model by combining the object notation language data structure, a reference to the electronic document, and a prompt template. The prompt template includes instructions for the language model to extract segments from the electronic document. The object notation language data structure defines the output of the image processing application or image processing applications. The reference is a reference to the electronic document itself, or a copy of the electronic document embedded in the prompt template. Thus, the combined information forms a single prompt (i.e., the multi-modal prompt) expressed in natural language text, one or more images, or a combination thereof. An example of a multimodal prompt is shown in FIG. 4F.

In an embodiment, generating the multimodal prompt may include retrieving a prompt template which includes an instruction to analyze a specified electronic document. The prompt template may be retrieved from a non-transitory computer readable storage medium, or from some other data repository. In this case, generating the multimodal prompt also includes adding, to the prompt template, the object notation language data structure. Then, generating the multimodal prompt further includes specifying that the specified electronic document is the electronic document.

Generating the multimodal prompt may include generating additional instructions instructing the language model to format the segments and the segment relationship in a specified format that is specific to the at least one relationship and the artifacts. In this case, step 206 also may include adding the additional instructions to the prompt template.

In another embodiment, the prompt template further includes a system message limiting how the language model is to analyze the specified electronic document. For example, the system message may inform the multimodal language model that the model should behave as if from the perspective of a truthful data analyst, or from the perspective of a data scientist. The constraint may influence how the multimodal language model executes.

In yet another embodiment, the system message may limit how the language model is to output a result of analyzing the specified electronic document. For example, the system message may instruct the multimodal language model to exclude certain types of output, or to provide output only in the form of a JSON file.

Step 208 includes applying, according to the multimodal prompt, the language model to the electronic document to extract, from the electronic document, the segments and a segment relationship among the segments. The language model includes programming for identifying segments and the relationships among the segments. However, additional information is present in the prompt (i.e., the object notation language data structure and possibly the system message or other instructions in the prompt). The additional information constrains the possible relationships that the language model might identify among the artifacts.

For example, the object notation language data structure in the prompt may specify that artifact A is related to artifact B. Thus, the language model must define that artifact A is related to artifact B. The relationship between the two artifacts may further constrain how artifact A and artifact B may be related to other artifacts in the electronic document. Thus, the probability of model hallucination is reduced or eliminated.

Other information in the prompt may further constrain the operation of the language model on the electronic document when identifying artifacts, segments, or segment relationships in the electronic document. For example, the system message may inform the language model that the language model should, or should not, make certain associations among the artifacts or segments of the electronic document.

In an embodiment, applying the language model may include executing, by a processor, the language model on the multimodal prompt and the electronic document. In other words, the language model concurrently processes the instructions in the prompt and the electronic document.

Step 210 includes returning the segments. Returning the segments includes storing or further processing the segments output by the language model.

As an example, returning the segments may include storing the segments in a non-transitory computer readable storage medium. Subsequently, if desired, the returning also may include building a knowledge graph using the segments. The knowledge graph may be stored in the non-transitory computer readable storage medium.

In another example, the electronic document may be a form. In this case, returning the segments includes generating, using the segments and the segment relationship, a computer executable program for filling out the form. In this case, returning also includes programming computer executable instructions for filling out the form according to the computer executable program.

FIG. 3 shows a flowchart of a method for validating and updating artifacts extracted by the method of FIG. 2, in accordance with one or more embodiments. The method of FIG. 3 may be performed using the system shown in FIG. 1.

Step 300 includes applying a server controller to determine a difference between a first dataset and a second dataset. The first dataset includes a number of artifacts extracted from an electronic document by an image processing application. The second dataset includes a number of segments extracted from the electronic document by a language model.

The differences may be determined by comparing artifacts identified by the language model to artifacts identified by the image processing application. For example, if an artifact is present in one dataset, but not the other, then the difference is stored for the next step.

Step 302 includes augmenting, to generate an updated segment using the difference, at least one of the segments extracted by the language model. Augmenting may include at least modifying the at least one of the segments using the first dataset.

However, augmenting may include modifying at least one of the segments using the second dataset. Thus, the difference noted above may be added to one data set or the other.

However, in an embodiment, artifacts present in the image processing dataset may be added to the artifacts generated by the language model dataset, but not vice versa. Similarly, artifacts in the language model dataset, but not in the image processing dataset, are removed from the language model dataset. In other words, the image processing artifacts are taken to be correct, while any differences in the language model dataset are taken to be incorrect. The artifacts, segments, and segment relationships generated by the language model may be updated accordingly.

In an embodiment, the differences may be added to the prompt generated above in FIG. 2. In this case, the improved dataset output by the language model may be converted to an object notation language data structure and then added to the prompt. The language model may then be executed again upon the prompt and the electronic document, thereby further improving the of the language model by further reducing the probability of model hallucination.

Step 302 may include additional augmentation. For example, metadata describing the segments may be added to the segments extracted by the language model. The metadata may add artifacts, artifact relationships, segments, or segment relationships. The metadata may add time constraints, or name certain artifacts. The metadata may include processing instructions for further defining how a knowledge graph may be generated from the language model output. The metadata may include additional information or constraints.

Step 304 includes returning modified segments in which the updated segment replaces the at least one of the segments. Returning the modified segments otherwise may be performed as described with respect to step 210 of FIG. 2, but instead with the modified output rather than the segments mentioned in step 210.

Thus, for example, the method also may include identifying a number of relationships among the segments. In this case, generating a graph data structure from the segments may be performed by specifying the segments as nodes and specifying the relationships as edges between the nodes.

In another example, the method also may include applying a graph database generator to the modified segments to generate a knowledge graph. The knowledge graph may then be used by, or be used to build, additional applications. For example, if the electronic form is a tax document, then the modified segments may be used by tax processing software, or be used to build the tax processing software.

While the various steps in FIG. 2 and FIG. 3 are presented and described sequentially, at least some of the steps may be executed in different orders, may be combined or omitted, and at least some of the steps may be executed in parallel. Furthermore, the steps may be performed actively or passively.

FIG. 4A, FIG. 4B, FIG. 4C, FIG. 4D, FIG. 4E, and FIG. 4F show an example of extracting artifacts from electronic documents using an augmented language model, in accordance with one or more embodiments. The following example is for explanatory purposes only and not intended to limit the scope of one or more embodiments.

FIG. 4A shows a variation of the method of FIG. 2. Initially, a tax form (400) is provided (e.g., retrieved from a data repository, transmitted to a server controller, etc.) The tax form (400) is processed by both an OCR program (402) (i.e., optical character recognition program) and a CV program (404) (i.e. a computer vision program). The output of the OCR program (402) is OCR data (406). The output of the CV program (404) is CV data (408).

The OCR data (406) and the CV data (408) are provided to an analysis engine (410). The analysis engine (410) may be the server controller (132) of FIG. 1 which processes the data according to the method of FIG. 2. For example, the two types of data may be converted into an object notation data structure and then combined into a single data structure for further processing.

The single data structure is then added to large language model prompt template (i.e., the LLM prompt template (412) shown in FIG. 4A). The resulting prompt is then provided as instructions to a large language model (i.e., LLM (414)), which then executes on the tax form (400) according to the prompt. In turn, the MLM (414) outputs extracted segments (416).

Attention is turned to FIG. 4B. FIG. 4B shows a method of validating the extracted segments (416) generated by the method of FIG. 4A. The extracted segments (416), the OCR data (406), and the CV data (408) are provided to a validation process (418). The validation process may be the server controller (132) of FIG. 1, which executes the method of FIG. 3.

The validation process (418) identifies differences among the OCR data (406) and the extracted segments (416), as well as differences among the CV data (408) an the extracted segments (416). The differences are used in an augmentation process (420). The augmentation process (420) ensures that the extracted segments (416) are in compliance with the OCR data (406) and the CV data (408). For example, data in the two datasets, but not in the extracted segments (416), are added to the extracted segments (416). Data in the extracted segments (416), but not in the other two datasets, may be removed.

The resulting augmented segments are output as validated updated segments (422). The validated updated segments (422) then may be used for further processing, as described with respect to FIG. 4A.

FIG. 4C shows an example of a form which may be stored as the electronic document (102) of FIG. 1, or the tax form (400) of FIG. 4A. The form (423) includes a number of artifacts, as indicated by the highlighted boxes. Each instance of text also may be an artifact. Thus, for example, artifact (424) is a bar code artifact, artifact (426) is a bounding box artifact, artifact (428) is a checkbox artifact, and artifact (430) is a text artifact. The form (423) may be processed according to the method of FIG. 2, FIG. 3, FIG. 4A, or FIG. 4B.

FIG. 4D shows an example of an object notation data structure generated as a result of applying image processing software to an electronic document. Specifically, the object notation data structure (432) shown in FIG. 4D is generated by converting the OCR data (406) and the CV data (408) from FIG. 4A into the object notation data structure (432). Thus, the artifacts are shown. One of the artifacts is a text segment (434) found in the form (423) in FIG. 4C, along with location data (436) defining the location of the text in a coordinate system defined for the form (423) shown in FIG. 4C. Many artifacts, including bounding boxes, other text, etc. are shown. Ellipses (438) indicate that many artifacts are defined for the form (423) shown in FIG. 4C, other than those artifacts shown in FIG. 4D.

FIG. 4E shows an example output of the large language model (414) shown in FIG. 4A when applied to the form (423) shown in FIG. 4C. The prompt instructed the large language model (414) to output the result of analysis in the form of an object notation language data structure (440), as shown in FIG. 4E. Again, as can be seen, each artifact (e.g., artifact (442)) that the large language model found in the form (423) of FIG. 4C is defined in the object notation language data structure (440). Ellipses (444) show that many artifacts are present in the object notation language data structure (440), other than those shown in FIG. 4E.

Differences can be seen between the object notation language data structure (440) shown in FIG. 4D and the object notation language data structure (432) shown in FIG. 4E. The differences may be reconciled according to the method shown in FIG. 3 or the method shown in FIG. 4B. The result of reconciliation may be to generate a revised version of the object notation language data structure (440), with the revised version constrained to contain artifacts present in the object notation language data structure (432) of FIG. 4D.

FIG. 4F shows an example of a prompt which may be applied as instructions to a language model when the language model is instructed to analyze a language document and output artifacts, segments, and segment relationships. Specifically, the prompt (446) instructs the LLM (414) of FIG. 4A to analyze the form (423) shown in FIG. 4A. The OCR data (406) and the CV data (408) generated by image processing software, as described with respect to FIG. 4A, is included in the prompt (446) as shown in data structure (448) that is part of the prompt (446). The data structure (448) is an object notation language data structure. Ellipsis (450) indicate that the data structure (448) is substantially longer than the instruction shown in FIG. 4F.

The prompt (446) also includes a system message (452). The system message (452) defines constraints imposed on the LLM (414) when the LLM (414) analyzes the form (423) in view of the instructions. In this case, the system message (452) instructs the LLM (414) to output the identified artifacts, segments, and segment relationships in an object notation language data structure, and further provides an example for the LLM (414) to follow when outputting said artifacts, segments, and segment relationships. As indicated by ellipses (454), many more instructions may be provided to the LLM (414) regarding how to format the output.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disc (CD), digital video disc (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system (500) shown in FIG. 5A, or a group of nodes combined may correspond to the computing system (500) shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system (500) shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
applying an image processing application to an electronic document to generate image processing data describing a plurality of artifacts in the electronic document;
applying a server controller to the image processing data to generate at least one relationship among the plurality of artifacts;
converting the at least one relationship and the plurality of artifacts into an object notation language data structure;
generating a multimodal prompt for a language model by combining the object notation language data structure, a reference to the electronic document, and a prompt template, wherein the prompt template comprises instructions for the language model to extract a plurality of segments from the electronic document;
applying, according to the multimodal prompt, the language model to the electronic document to extract, from the electronic document, the plurality of segments and a segment relationship among the plurality of segments; and
returning the plurality of segments.

2. The method of claim 1, wherein returning the plurality of segments comprises:
storing the plurality of segments in a non-transitory computer readable storage medium,
building a knowledge graph using the plurality of segments, and
storing the knowledge graph in the non-transitory computer readable storage medium.

3. The method of claim 1, wherein the electronic document comprises a form and wherein returning the plurality of segments comprises:
generating, using the plurality of segments and the segment relationship, a computer executable program for filling out the form, and
programming computer executable instructions for filling out the form according to the computer executable program.

4. The method of claim 1, wherein the plurality of artifacts comprise at least one of a bounding box, a text string within a bounding box, a text string outside a bounding box, a bar code, a Quick Response (QR) code, a contour of the electronic document, a field, a checkbox, and an amount of pixel fill within a bounding box.

5. The method of claim 1,
wherein the electronic document comprises a plurality of pixels, and
wherein applying the image processing application comprises analyzing the plurality of pixels to identify the plurality of artifacts.

6. The method of claim 5, wherein analyzing the plurality of pixels comprises identifying contiguous pixels that form text, and further identifying a font size, font type, and a language formed by the text.

7. The method of claim 5, wherein analyzing the plurality of pixels comprises identifying contiguous pixels that form a bounding box and a relationship of textual content relative to the bounding box.

8. The method of claim 5,
wherein the at least one relationship and the plurality of artifacts comprise a bounding box and text associated with the bounding box, and
wherein converting comprises:
establishing a coordinate system for the electronic document,
identifying, in the object notation language data structure, the text as content,
reproducing, in the object notation language data structure, the text as being directly associated with the content,
identifying, in the object notation language data structure, the bounding box as a bound,
specifying, in the object notation language data structure, coordinates of the bounding box relative to the coordinate system, and
specifying, in the object notation language data structure, a relationship between the bounding box and the text.

9. The method of claim 1, wherein generating the multimodal prompt comprises:
retrieving a prompt template comprising an instruction to analyze a specified electronic document,
adding, to the prompt template, the object notation language data structure, and
specifying that the specified electronic document is the electronic document.

10. The method of claim 9, wherein generating the multimodal prompt further comprises:
generating additional instructions instructing the language model to format the plurality of segments and the segment relationship in a specified format that is specific to the at least one relationship and the plurality of artifacts, and
adding the additional instructions to the prompt template.

11. The method of claim 9, wherein the prompt template further comprises a system message limiting how the language model is to analyze the specified electronic document.

12. The method of claim 9, wherein the prompt template further comprises a system message limiting how the language model is to output a result of analyzing the specified electronic document.

13. The method of claim 1, wherein applying the language model comprises:
executing, by a computer processor, the language model on the multimodal prompt and the electronic document.

14. A method comprising
applying a server controller to determine a difference between a first dataset and a second dataset,
wherein the first dataset comprises a plurality of artifacts extracted from an electronic document by an image processing application, and
wherein the second dataset comprises a plurality of segments extracted from the electronic document by a language model;
augmenting, to generate an updated segment using the difference, at least one of the plurality of segments extracted by the language model, wherein augmenting at least comprises modifying the at least one of the plurality of segments using the first dataset; and
returning a modified plurality of segments comprising the plurality of segments in which the updated segment replaces the at least one of the plurality of segments.

15. The method of claim 14, further comprising:
identifying a plurality of relationships among the plurality of segments; and
generating a graph data structure from the plurality of segments by specifying the plurality of segments as nodes and specifying the plurality of relationships as edges between the nodes.

16. The method of claim 14, wherein augmenting further comprises adding metadata describing the plurality of segments.

17. The method of claim 14, further comprising:
applying a graph database generator to the modified plurality of segments to generate a knowledge graph.

18. A system comprising
a computer processor;
a data repository in communication with the computer processor and storing:
an electronic document,
a reference to the electronic document,
image processing data describing a plurality of artifacts in the electronic document,
at least one relationship among the plurality of artifacts,
an object notation language data structure,
a prompt template comprising natural language instructions to extract a plurality of segments from the electronic document,
a multimodal prompt, and
a segment relationship among the plurality of segments;
an image processing application programmed, when executed by the computer processor, to generate the image processing data from the electronic document;
a server controller programmed, when executed by the computer processor, to:
generate, from the image processing data, the at least one relationship among the plurality of artifacts,
convert the at least one relationship and the plurality of artifacts into the object notation language data structure,
generate the multimodal prompt by combining object notation language data structure, the reference to the electronic document, and the prompt template, and
return the plurality of segments; and
a language model programmed, when executed by the computer processor according to the multimodal prompt, to extract, from the electronic document, the plurality of segments and the segment relationship.

19. The system of claim 18, further comprising:
a knowledge graph generator which, when executed by the computer processor, is programmed to generate a graph database from the plurality of segments and the segment relationship extracted from the electronic document.

20. The system of claim 18,
wherein the electronic document comprises a form, and
wherein the system further comprises a program generator which, when executed by the computer processor, is programmed to generate, using the plurality of segments and the segment relationship, a computer executable program for filling out the form.
